(19) United States
(12) Patent Application Publication
(10) Pub. No.: US 2023/0120590 A1
(43) Pub. Date: Apr. 20, 2023

(54) LASER SOLDERING DEVICE APPLYING MULTI NOZZLE AND THE METHOD THEREOF

(71) Applicants: Byoung Chan CHOI, Gwangmyeong-si (KR); Ki Seok KANG, Sokcho-si (KR); LASERVALL TECHNOLOGY CO., LTD., Suwon-si (KR)

(72) Inventors: Byoung Chan CHOI, Gwangmyeong-si (KR); Ki Seok KANG, Sokcho-si (KR)

(73) Assignees: Byoung Chan CHOI, Gwangmyeong-si (KR); Ki Seok KANG, Sokcho-si (KR); LASERVALL TECHNOLOGY CO., LTD., Suwon-si (KR)

(21) Appl. No.: 17/987,858

(22) Filed: Nov. 15, 2022

Related U.S. Application Data
(63) Continuation of application No. PCT/KR2021/014539, filed on Oct. 19, 2021.

(51) Int. Cl. B23K 1/005; B23K 3/06

(52) U.S. Cl. CPC B23K 1/0056; B23K 3/0623

(57) ABSTRACT

The present invention provides a laser soldering device including a transfer unit configured to transfer a plurality of objects, a solder unit configured to operate under control of the controller to solder the object positioned on the transfer unit, and form a bonding surface by performing the soldering by a laser beam, and at least one nozzle unit in which a solder ball to which the laser beam is irradiated is accommodated, in which the laser beam irradiated from the solder unit is eccentric with respect to a center line of the solder ball and adjusted to be irradiated.

### TECHNICAL FIELD

The present invention relates to a laser soldering device applying a multi nozzle, and a method thereof.

### BACKGROUND ART

In recent years, miniaturization and thinness of electronic devices are rapidly progressing. In addition, the miniaturization and thinness are also required for electronic components such as semiconductor devices mounted on such electronic devices. Electronic components are becoming denser, and the number of connection terminals is increasing.

As an electronic component mounting method for meeting these requirements, a method of surface-mounting a solder ball as an external connection terminal on a mounting board such as a printed circuit by mounting of a flip chip or the like has been recently applied. This mounting method is a method of directly bonding a solder ball to an electrode of a mounting board after mounting the solder ball on an electrode installed on a substrate of an electronic component.

Therefore, when the surface mounting method using the solder ball is applied, a method of positioning a solder ball on an electrode of a substrate in which the solder ball is mounted on the substrate of the electronic component and then heating and melting the solder ball to bond the solder ball to the electrode is generally used.

Among these soldering methods, a method of heating and melting a solder ball by irradiating a laser beam to a surface of the solder ball for high-accuracy and high-quality soldering has been recently applied. However, a preset laser irradiation position changes due to an external shock or external vibration, or a molten state of the solder ball changes due to a laser irradiation position setting error by an operator, so the soldering position and soldering quality may deteriorate.

### DISCLOSURE

### Technical Problem

The present invention provides a laser soldering device applying a multi nozzle capable of greatly improving accuracy of a laser irradiation position for heating and melting a solder ball, and a method thereof.

### Technical Solution

To accomplish the above problems, a laser soldering device applying a multi nozzle according to the present invention includes:

a controller;

a transfer unit configured to transfer a plurality of objects;

a solder unit configured to operate under control of the controller to solder the object positioned on the transfer unit, and form a bonding surface by performing the soldering by a laser beam; and

at least one nozzle unit in which a solder ball to which the laser beam is irradiated is accommodated,

in which the laser beam irradiated from the solder unit may be eccentric with respect to a center line of the solder ball and adjusted to be irradiated.

The laser beam irradiated from the solder unit may be adjusted and irradiated while having a predetermined offset within a diameter of the solder ball.

According to an embodiment of the present invention, the solder unit may include:

a laser generator configured to generate the laser beam for applying heat to the solder ball;

at least one beam converter configured to adjust an output area or a shape of the laser beam; and

at least one head unit configured to applying the laser beam, which passes through the beam converter and is irradiated to the object, to the solder ball.

The nozzle unit may be provided in plurality and may be formed to be selectively usable according to a size of the solder ball.

The nozzle unit may be provided in plurality, and one end portion of the nozzle unit may have a different diameter.

At least one of a dynamic focusing module and a camera module may be formed on one side of the solder unit.

The laser beam emitted from the solder unit may be a laser beam including a plurality of wavelengths, and each wavelength may be transmitted to the object of different types or the same type to perform at least one of soldering, bonding, welding, and the like.

The solder unit may further include an imaging unit configured to process an image of the object through the head unit.

The transmission of the laser may be a fiber laser or a diode laser transmitted through an optical fiber to the head unit.

A core of the optical fiber may be formed in a circular or polygonal shape.

The object may be pre-bonded and transferred by the transfer unit.

The laser beam may be irradiated with an output in a flat-top type.

A transfer target of the transfer unit may further include a substrate, and the substrate may be disposed so that the object is stacked on the substrate.

One side of the solder unit may be provided with a sensor unit measuring a profile of the laser beam.

One side of the solder unit may be provided with a sensor unit measuring a position of the laser beam irradiated into a surface of the solder ball or the nozzle.

One side of the solder unit may be provided with a sensor unit measuring a size of the laser beam irradiated into a surface of the solder ball or the nozzle.

One side of the solder unit may be provided with a sensor unit measuring a melting temperature or a heat distribution of the solder ball.

One side of the solder unit may be provided with a sensor unit measuring a temperature or a heat distribution of the object.

The present invention provides a soldering method using the laser soldering device applying a multi nozzle described above, including:

a transferring step of disposing an object on a transfer unit;

a monitoring step of recognizing a shape and center of a nozzle unit or a position of a solder ball accommodated in the nozzle unit;

a soldering step of irradiating a laser beam from a laser generator of a solder unit to the solder ball; and

an error range adjustment step of adjusting an irradiation position of the laser beam by checking a displacement of the solder ball according to a change in the position of the solder ball or the nozzle unit.

In the error range adjustment step, the irradiation position of the laser beam may be corrected and adjusted to compensate for a displacement separated from a center line of the solder ball or the nozzle unit.

Detailed contents of other exemplary embodiments are described in a detailed description and are illustrated in the drawings.

### Advantageous Effects

According to a laser soldering device applying a multi nozzle and a method thereof according to the present invention, by constituting an intelligent optical engine capable of removing an error range of laser irradiation for soldering to enable correction in X, Y, and Z directions for the error range, it is possible to greatly improve accuracy of an irradiation position according to laser irradiation.

The effects of the present invention are not limited to the above-described effects. That is, other effects that are not described may be obviously understood by those skilled in the art from the claims.

### BRIEF DESCRIPTION OF THE DRAWINGS

FIG. 1 is a schematic configuration diagram of a laser soldering device applying a multi nozzle according to an embodiment of the present invention.

FIG. 2 is a diagram illustrating a soldering operation of the laser soldering device according to an embodiment of the present invention.

FIG. 3 is a diagram illustrating a nozzle unit of a laser soldering device according to another embodiment of the present invention.

FIG. 4 is a diagram illustrating a state of preheating and heating through a laser according to an embodiment of the present invention,

FIGS. 5A and 5B are diagrams illustrating a disposition of an object to be processed according to an embodiment of the present invention.

FIG. 6 is a diagram illustrating a configuration of an optical fiber 610 for transmitting a laser according to an embodiment of the present invention.

FIG. 7 is a flowchart illustrating a process of operating a soldering device according to an embodiment of the present disclosure.

FIG. 8 is a diagram illustrating a conventional laser jet soldering problem.

FIG. 9 is a diagram illustrating an influence of a soldering position and quality according to irradiation position X and Y directions of a solder ball or a solder nozzle and a laser beam.

FIG. 10 is a diagram illustrating the influence of the soldering position and quality according to a laser beam irradiation position Z-direction (focus height position) to the solder ball.

FIG. 11 is a diagram illustrating a nozzle damage effect according to a size and cone angle of the irradiated laser beam.

FIGS. 12 to 15 are configuration diagrams and embodiments of a three-dimensional optical engine capable of adjusting a laser irradiation position.

### BEST MODE

Hereinafter, embodiments of the present disclosure will be described in detail with reference to the accompanying drawings. It is to be noted that in giving reference numerals to components of the respective drawings, the same components will be denoted by the same reference numerals even though they are illustrated in different drawings. Further, in describing embodiments of the present disclosure, well-known constructions or functions will not be described in detail in the case in which it is decided that they may unnecessarily obscure the understanding of embodiments of the present disclosure.

Terms ‘first’, ‘second’, A, B, (a), (b), and the like, will be used in describing components of embodiments of the present disclosure. These terms are used only in order to distinguish any component from other components, and features, sequences, or the like, of corresponding components are not limited by these terms. In addition, unless defined otherwise, all the terms used in the present specification, including technical and scientific terms, have the same meanings as meanings that are generally understood by those skilled in the art to which the present disclosure pertains. It should be interpreted that terms defined by a generally used dictionary are identical with the meanings within the context of the related art, and they should not be ideally or excessively formally interpreted unless the context clearly dictates otherwise.

By a soldering device and method to which a multi-nozzle is applied according to an embodiment of the present invention, a laser processing process such as marking, drilling, bonding, welding, and soldering may be performed on a laser processing target. Hereinafter, the laser soldering device and method of the present invention will be described as an example for performing soldering. That is, only a process for soldering may be performed by employing a laser processing device as the soldering device. Hereinafter, in this case, the laser processing device may be described as the soldering device.

In addition, hereinafter, rework may mean including a process (work) of re-soldering due to poor solder or an insufficient amount of solder, or re-soldering after removing a soldered portion due to poor soldering quality.

Furthermore, a multi-laser soldering device according to an embodiment of the present invention may be included in various processes such as welding, soldering, and bonding, and as materials for each process, various materials such as polymer, metal, dielectric, semiconductor, and glass may be applied.

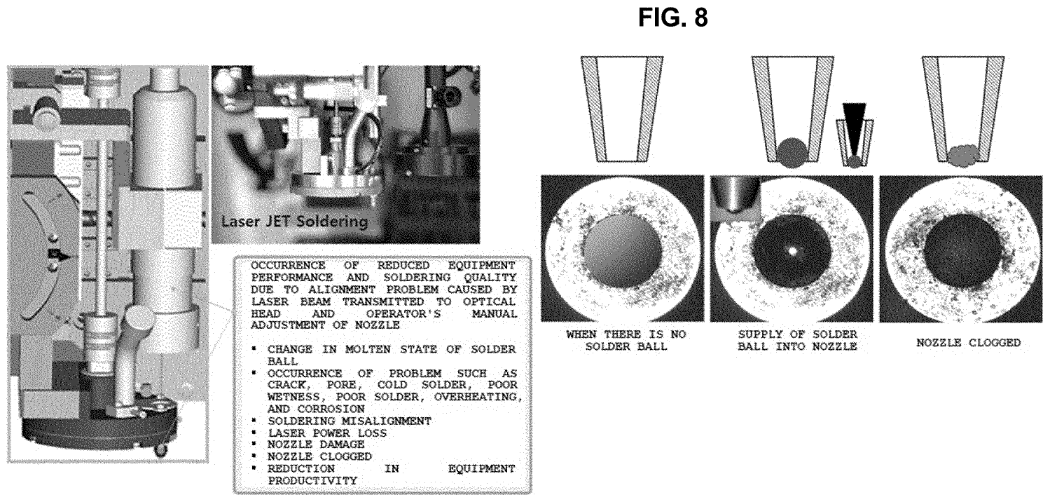

As described above, in the case of conventional jet soldering, as illustrated in FIG. 8, there was an alignment problem due to a manual adjustment method of an operator for a laser beam and a nozzle transmitted to an optical head.

Accordingly, in the present invention, as described below, laser irradiation positions x, y, and z may be adjustable to greatly improve accuracy of laser irradiation positions for heating and melting the solder ball.

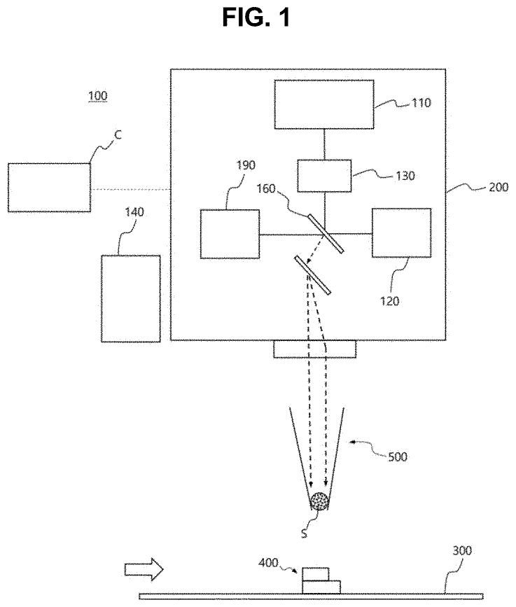

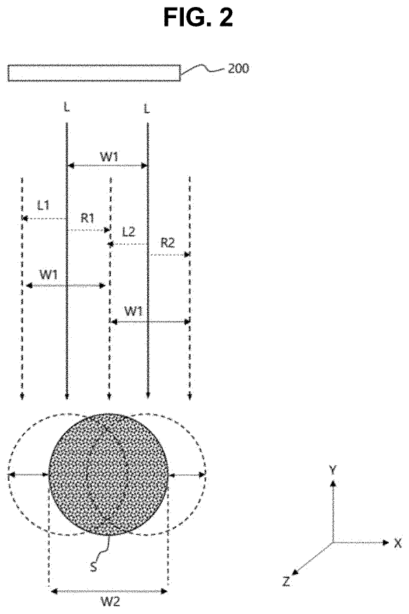

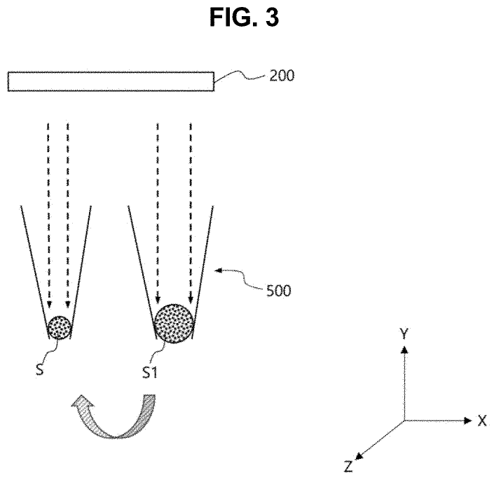

FIG. 1 is a schematic configuration diagram of a laser soldering device applying a multi nozzle according to an embodiment of the present invention, FIG. 2 is a diagram illustrating a soldering operation of the laser soldering device according to an embodiment of the present invention, and FIG. 3 is a diagram illustrating a nozzle unit of a laser soldering device according to another embodiment of the present invention.

Referring to FIGS. 1 to 3, a laser soldering device 100 according to an embodiment of the present invention may include a controller C and a solder unit 200. Here, the solder unit 200 is a pair of laser generators 110 and 120 that generate a laser beam that applies heat to a solder ball S, a beam converter 130 that adjusts an output area or shape of the laser beam, and at least one head unit 230 that applies the laser beam, which passes through the beam converter 130 and is irradiated to an object, to the solder ball S. In addition, the solder unit 200 of the laser soldering device 100 according to the present invention irradiates the laser passing through the beam converter 130 to the solder ball S discharged between objects 400, and may further include a nozzle unit 500 that discharges the solder ball S, a monitoring unit 140 that measures a position of the nozzle unit 500 on which the solder ball S is disposed, and a sensor unit 190. According to the present invention, the monitoring unit 140 may be, for example, a dynamic focusing module or a camera module, but is not limited thereto.

Here, the laser soldering device 100 according to the present invention may monitor and calculate a displacement according to a change in the position of the nozzle unit 500 provided so that the laser beam is irradiated and discharged to the solder ball S, and move the nozzle unit 500 to a predetermined distance/angle, thereby removing a soldering error range due to a clearance of the nozzle unit.

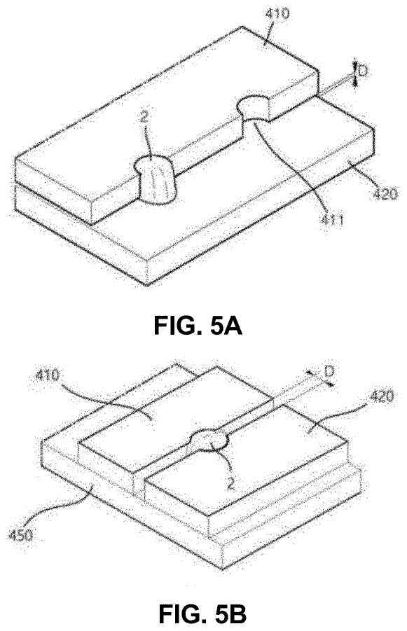

Specifically, in the laser soldering device 100 according to the present invention, the solder ball S may be sequentially moved from an external transfer means (not illustrated) by gravity or transfer auxiliary gas and supplied to the nozzle unit 500. In this case, the solder ball S may be supplied to the nozzle unit 500 side at an appropriate speed by the transfer auxiliary gas. The solder ball S is formed in a substantially spherical shape and is made of a metal alloy and may be melted by laser irradiation or the like. The solder ball 5 may be used to attach an electronic component or an electric component to a substrate 450 (FIG. 5). Here, the solder ball may be made of a single material such as a polymer, glass, metal, or a mixture.

The solder ball 5 supplied to the nozzle unit 500 moves downward along an inner surface of the nozzle unit 500, and may eventually reach a nozzle tip (not illustrated). The nozzle tip moves to a position to be applied to the solder ball S, and the solder ball S reaching the nozzle tip may be melted by a laser and applied to the substrate 450 (FIG. 5). As described above, to separate the solder ball 5 from the nozzle tip of the nozzle unit 500, the solder ball 5 may be naturally separated from the nozzle unit 500 only by melting the solder ball 5 with a laser without the need to separately supply gas, etc., and applied to the substrate, or to improve the efficiency and quality of the soldering process, the solder ball S may be separated from the nozzle unit 500 by supplying a separate auxiliary gas. The laser may be irradiated inclined downward with respect to a central axis of the nozzle unit 500. In addition, the laser may be irradiated from both sides with respect to the solder ball S. Therefore, the solder ball S may be effectively melted by the laser.

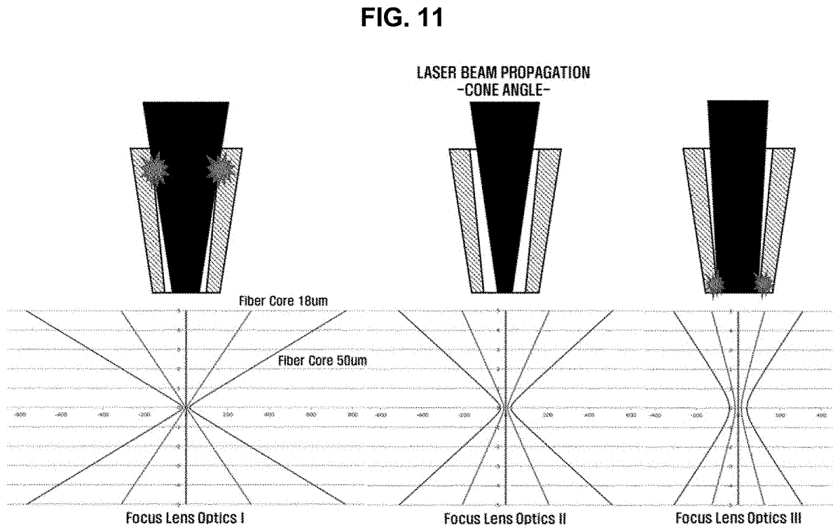

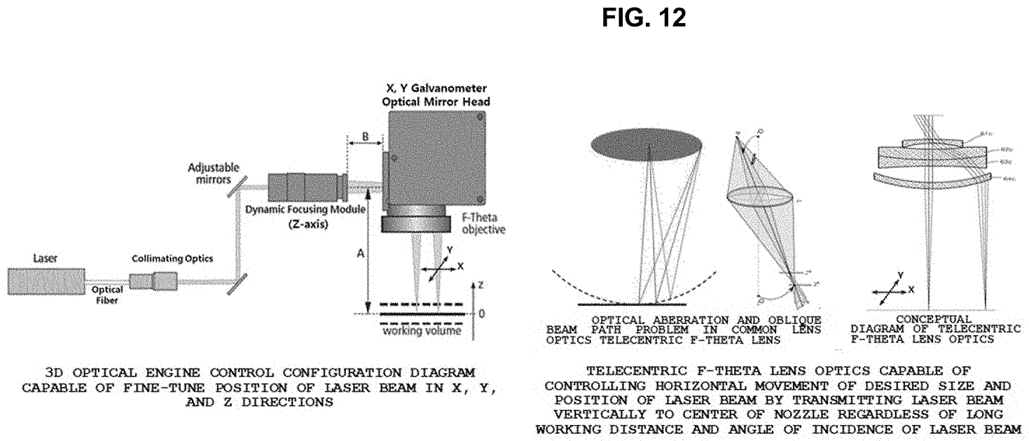

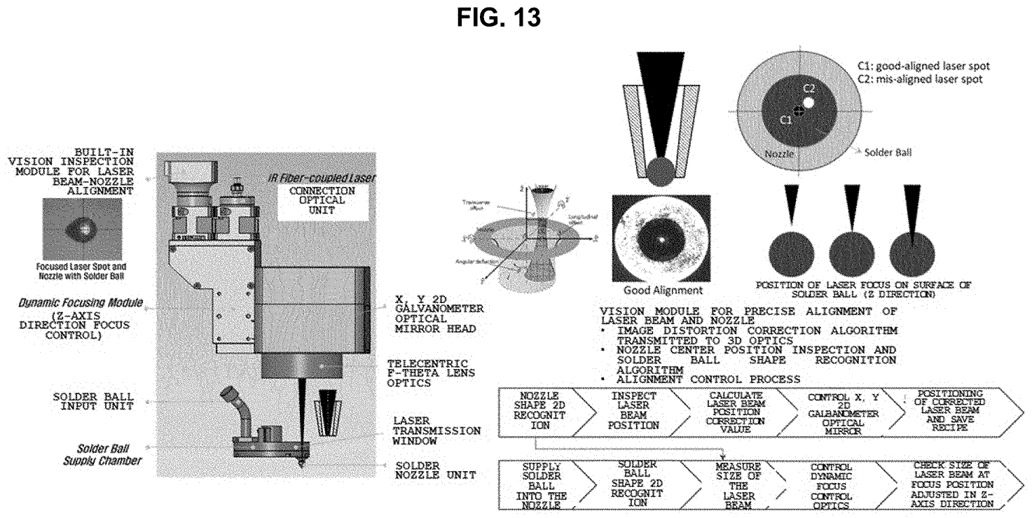

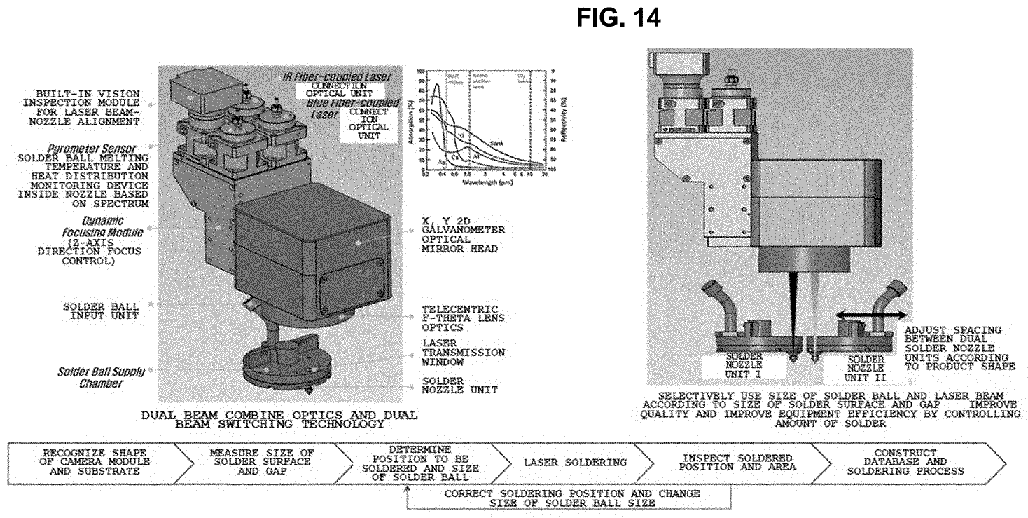

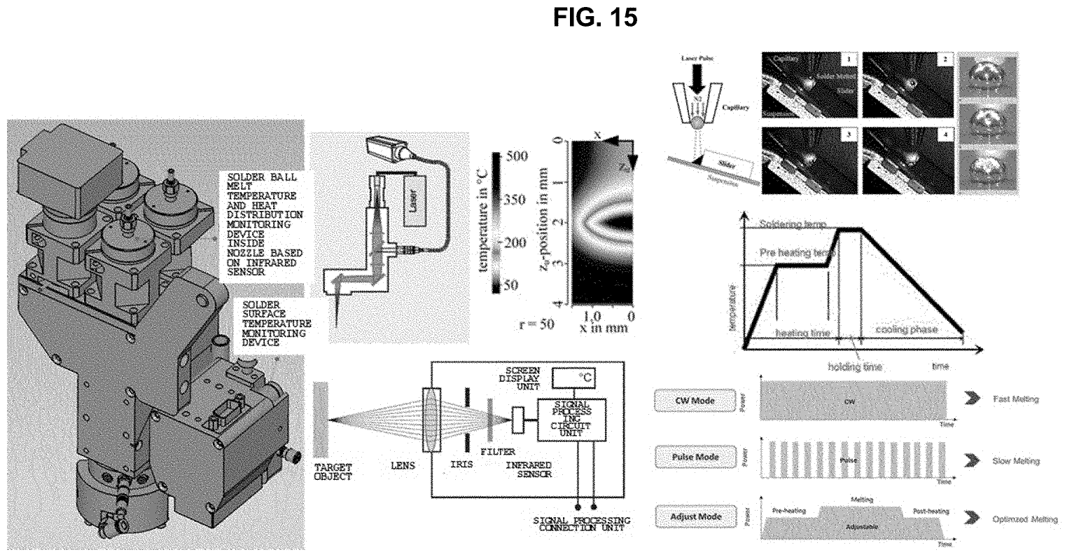

Here, also, as illustrated in FIG. 11, since the nozzle may be damaged depending on a size of the laser beam, a position and range of the laser beam irradiated to the nozzle unit 500 according to the present invention may be adjusted corresponding to an offset range generated by the flow of the nozzle unit 500. That is, the laser beam irradiated from the laser generators 110 and 120 of the solder unit 200 may be irradiated by changing the irradiation position variably according to a size change or a position change of the solder ball S.

Specifically, as illustrated in FIG. 2, the laser beam L irradiated from the solder unit 200 of the laser soldering device 100 according to the present invention may be irradiated to the solder ball S while having a predetermined width W1. Preferably, the width W1 of the laser beam L may be smaller than or equal to a width W2 of the solder ball S.

Here, when the laser beam L irradiated to the solder ball S is generally designed to be irradiated to a central point position of the solder ball S, and therefore, flows due to external force such as a focus height error of the laser beam irradiated to a surface of the solder ball S, vibration of the nozzle unit 500, or the like, as the position of the solder ball S moves, the entire portion of the solder ball S may not be effectively melted. Therefore, according to the present invention, to compensate for a displacement of a position of the nozzle unit 500 or the solder ball S by monitoring the displacement of the position in real time, by varying the irradiation position of the laser beam L or moving or adjusting the irradiation width W1 of the irradiated laser beam L, it is possible to correct an error according to a change in the position of the nozzle unit 500 or the solder ball S or a laser beam according to a change in a size of the solder ball S.

In a specific example, when the solder ball S moves in one direction, the laser beam L irradiated from the solder unit 200 of the laser soldering device 100 may be irradiated to a position moved in one direction corresponding to the movement direction of the solder ball S. That is, as illustrated in FIG. 2, when the solder ball S moves in a left direction, both end portions of the width W1 of the solder ball S may move to a first point L1 and a second point L2, respectively, so the laser beam L may be irradiated, and when the solder ball S moves in a right direction, both end portions of the width W1 of the solder ball S may move to a third point R1 and a fourth point R2, respectively, so the laser beam L may be irradiated. In addition, the molten state of the solder ball may be controlled by adjusting the focus height position of the laser beam irradiated to the solder ball S, that is, the focus position in the vertical direction (Z direction). In addition, the width W1 to which the laser beam L irradiated to the solder ball S is irradiated may be variably adjusted. That is, the width W1 of the laser beam L irradiated from the solder unit 200 may be narrowed or widened to a predetermined width according to the molten state of the solder ball S within the width W2 range of the solder ball S.

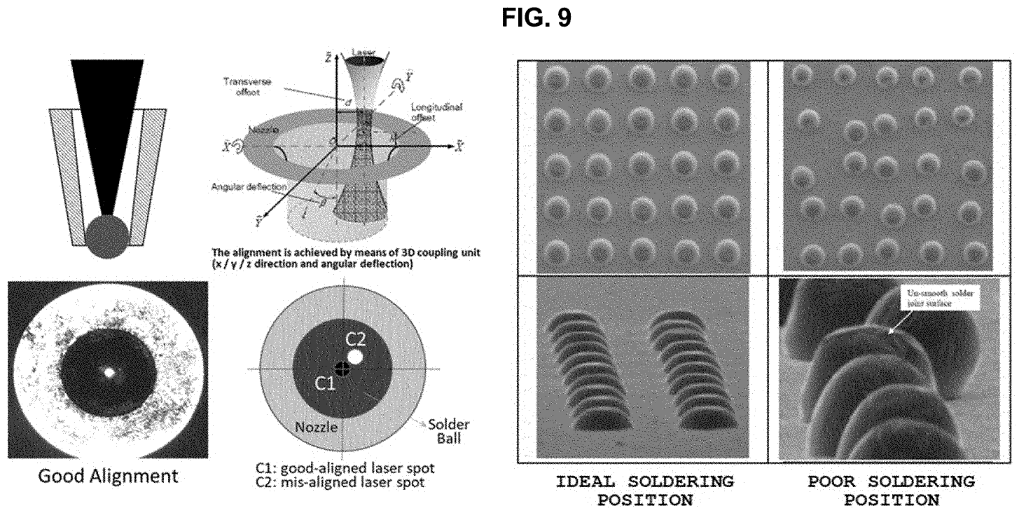

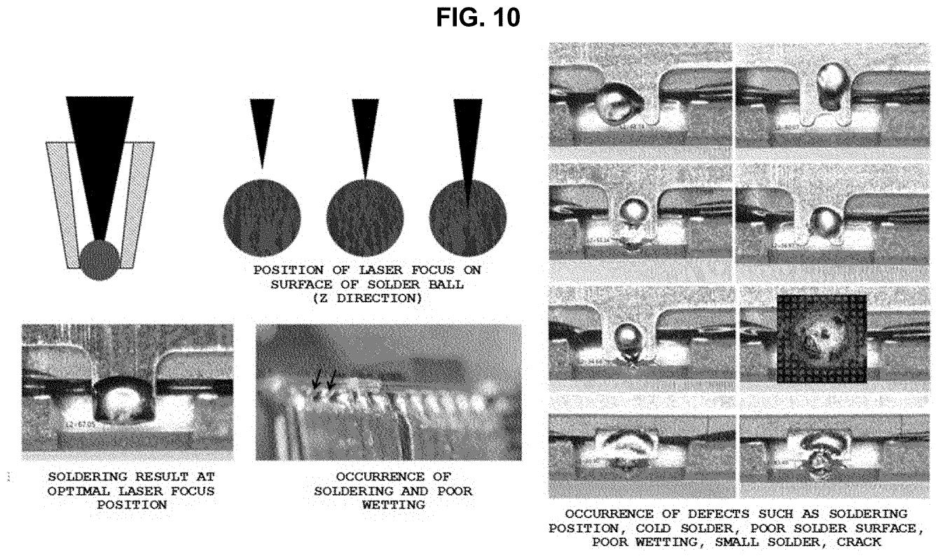

In this way, the irradiation position and the irradiation width W2 of the laser beam L may be controlled through the controller C, and the controller C may determine the x, y, and z coordinates that are the coordinates of the focus of the laser beam L by using the sensing value input and measured from the monitoring unit 140. For these focus coordinates, the laser beam L passing through the beam converter 130 may have a z-axis focus position adjusted by a dynamic focusing module (not illustrated), and have an x-axis and y-axis focus position adjusted by a scan head (not illustrated). An x-axis scan mirror and a y-axis scan mirror of the scan head may reflect the laser beam L to irradiate the laser beam L to a desired position of the object 400. The x-axis scan mirror and the y-axis scan mirror are composed of a pair of scan mirrors in a galvanometer manner, and each of the pair of scan mirrors may deflect a laser beam in one of the axes transverse to the x-y plane. In the present invention, as illustrated in FIGS. 9 to 10, by adjusting the focus coordinates x, y, and z of the laser beam L, it is possible to confirm the ideal soldering position adjustment and quality improvement.

Furthermore, as illustrated in FIG. 3, a laser soldering device 100 according to another embodiment of the present invention may be configured in a form in which a plurality of laser nozzle units 500 are disposed. That is, the nozzle unit 500 is in plurality, and each nozzle unit 500 may have nozzle tips (not illustrated) having a different width so that solder balls S and S1 having different diameters can be stored. Therefore, depending on the environment in which the laser beam L is irradiated to a substrate 450 (FIG. 5), the solder balls S and S1 having different diameters may be selectively used corresponding to the case where the irradiation position is narrow or wide to irradiate the laser beam L. Similarly, the irradiation position and the irradiation width W2 of the laser beam L may be controlled through the controller C, and the controller C may determine the x, y, z coordinates that are the coordinates of the focus of the laser beam L by using the sensing value input and measured from the monitoring unit 140.

In some cases, although not illustrated in the drawings presented by the present invention, by providing a plurality of head units 230 for irradiating the laser beam of the solder unit 200 to simultaneously or selectively irradiate the laser beam, the width W1 at which the laser beam L is irradiated may be variably adjusted.

Meanwhile, the laser generators 110 and 120 may include a first laser generator 110 that generates a laser to apply heat to a portion of the object 400 and preheat the portion of the object 400 and a second laser generator 120 that generates a laser to directly apply heat to the solder ball S and melt the solder ball S. A cross-sectional area or shape of the laser generated from the first laser generator 110 and/or the second laser generator 120 may be adjusted through the beam converter 130. In this case, the cross-sectional area of the adjusted beam may be the cross-sectional area of the laser to be irradiated toward the object 400. The laser passing through the beam converter 130 may be transmitted to the head unit 230, and primary soldering in which the molten solder ball S is discharged from the head unit 230 may be performed, and secondary soldering in which the molten solder ball S is distributed to the object 400 may be performed.

Here, before the laser is irradiated from the second laser generator 120, the process of preheating the portion of the object 400 from the first laser generator 110 and the portion of the substrate 450 (FIG. 5) on which the object 400 is seated may be included. Preferably, the preheating process may be performed before the operation of the second laser generator 120. This may be controlled, through, for example, the controller C.

Specifically, in the multi-laser soldering device 100 according to the present invention, the preheating process by the first laser generator 110 and the melting process by the second laser generator 120 may be sequentially performed. That is, the multi-laser soldering device 100 according to the present invention first generates a laser to the portion of the object 400 by the first laser generator 110 to preheat the irradiated portion, and then may reduce the deviation from the heating temperature during laser irradiation of the second laser generator 120. In this way, the bonding process through the laser irradiated through the second laser generator 120 may be performed more efficiently. For example, a laser of about 10 A intensity may heat the portion of the object 400 by being irradiated to the portion of the object 400 through the second laser generator 120 for a predetermined time so that the object 400 may reach a specific temperature point A, and then a relatively high laser of about 15 A intensity may be irradiated to the object 400 through the second laser generator 120 for a predetermined time so that the object 400 reaches a specific temperature point C, thereby facilitating the melting and bonding process of the object 400.

Furthermore, when the laser is irradiated through the second laser generator 120 after the preheating process by the above-described first laser generator 110, the laser may be irradiated with a relatively smaller intensity than the actually set intensity and lowered to a specific temperature point. Accordingly, in the present invention, in order to correct this error, the correction process may be performed by a method of correcting an error by additionally heating the corresponding portion through the first laser generator 110 or increasing power of the second laser generator 120. Also, of course, the beam converter 130 may be formed between the second laser generator 120 and the beam splitter 160.

In addition, the sensor unit 190 may include a sensor that detects the melting temperature or heat distribution of the solder ball S according to the laser irradiation, a thermal temperature distribution sensor that detects a temperature distribution of the object 400, a laser power sensor that detects a laser irradiation intensity, a beam position sensor that detects a laser irradiation position, a laser profile, a bonding quality inspection device, and the like. The sensor unit 190 may transmit/receive the sensing result to the controller C. Here, in the bonding of the object 400, the bonding quality inspection device includes material characteristics, a bonding method, and bonding quality (bonding area, bonding depth, bonding strength, crack of bonding portion, void, cold solder, poor solder, excess solder, degree of heat effect, etc.) may be recorded.

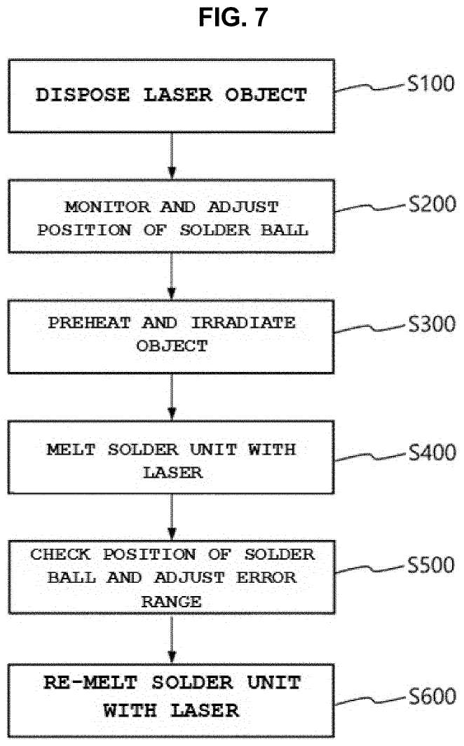

Hereinafter, the soldering process using the laser soldering device 100 capable of adjusting the position described above will be described with reference to FIG. 7.

First, the transfer unit 300 of the laser soldering device 100 capable of adjusting the position of the present invention may transfer the object 400 and dispose an object at a target point (S100). In the transfer unit 300, a separate substrate 450 may be additionally interposed under the object 400.

Thereafter, the position of the solder ball S of the nozzle unit 500 is checked in real time through the monitoring unit 140 formed on one side of the solder unit 200, and when there is a change in the position of the solder ball S, the irradiation position of the laser beam L irradiated from the solder unit 200 may be adjusted (S200). In this case, in the process of adjusting the irradiation position of the laser beam L, the irradiation position may be adjusted according to a numerical value calculated by measuring a changed displacement by comparing with the previously measured position of the solder ball S with the irradiation position.

Then, the portion of the object 400 to be bonded from the first laser generator 110 may be heated by irradiating a laser (S300). In this case, the preheating portion to be heated including the object 400 may include the substrate 450. By allowing the preheating process to be performed by the laser irradiated from the first laser generator 110, it is expected to improve the wettability and quality of the soldering process according to the reduction of the temperature deviation.

In addition, the bonding of the object 400 may be performed through the melting of the solder ball S by the laser irradiation by the second laser generator 120 (S400). In addition, when the intensity of the laser is reduced or changed, the laser intensity of the second laser generator 120 for correcting this may be adjusted through the controller C. In this case, as described above, by directly correcting the laser intensity of the second laser generator 120 or by additionally irradiating the laser through the first laser generator 110 to provide a heat source to correct the laser intensity, it is possible to effectively maintain the soldering efficiency.

During or after the bonding process (S400) according to the laser irradiation, by additionally monitoring the change in the position of the solder ball S of the nozzle unit 500 through the monitoring unit 140 formed on one side of the solder unit 200, the laser beam L may be irradiated by correcting or moving the irradiation position of the laser beam L to adjust the error range (S500 and S600). Therefore, by adjusting this error range, that is, by preventing the case where only one side of the solder ball S is melted or eccentrically irradiated during the melting process, the soldering efficiency can be greatly improved.

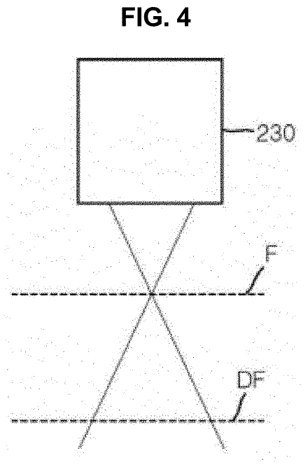

FIG. 4 is a diagram illustrating a state of preheating and heating through a laser according to an embodiment of the present invention, and FIGS. 5A and 5B are diagrams illustrating the disposition of the first object 410 and the second object 420 according to an embodiment of the present invention. FIG. 5A is a diagram illustrating that the first object 410 and the second object 420 are disposed with a predetermined separation distance, and solder bumps 2 are positioned at a separation distance and bonded to each other, and FIG. 5B is a diagram illustrating that the first object 410 and the second object 420 according to another embodiment of the present invention are bonded on a separate substrate 450.

Referring to FIG. 5A, the objects 400 (410 and 420) may be disposed with a step or a predetermined separation distance D. For example, a concave bonding surface 411 on which the solder bump 2 may be positioned may be formed on the first object 410, and a bonding surface 411 may be formed between the first object 410 and the second object 420 disposed to form a step.

The concave bonding surface 411 on which the solder bump 2 may be positioned may be formed on the first object 410, and the bonding surface 411 may be formed on the second objects 420 facing each other with the separation distance D. In this example, two bonding surfaces 411 may be formed, and the objects 400 disposed with a step or a separation distance D may be bonded while the solder bumps 2 are positioned on the bonding surface 411.

In the above-described secondary soldering process, the laser is irradiated while the solder bump 2 are positioned to further melt the solder bump 2 so that the liquid solder may be distributed in the space formed by the step or separation distance D. The distribution may be expected to increase or improve bonding strength by increasing the bonding surface area between the first object 410 and the second object 420 after curing the solder.

It is possible to increase the bonding strength as the melted solder bump 2 improves the wettability. The improvement in the wettability may be degraded due to the temperature difference between the object 400 and the solder bump 2. The temperature of the object 400 is room temperature, and the temperature difference may occur between the high-temperature solder bumps 2 positioned partially melted by the laser. When the wettability on the bonding surface 411 of the first object 410 is reduced due to the temperature difference, the contact area between the solder bump 2 and the object 400 may be reduced.

Accordingly, in order to improve the wettability, the preheating process for reducing the temperature difference may be performed. In this preheating process, as described above, in addition to the method by the additional laser irradiation of the first laser generator 110, by adjusting the height of the head unit 230, it may be performed by forming the separation distance between the laser focus and the object by being spaced apart from the laser focus. FIG. 4 is a diagram illustrating the state in which the preheating and heating may be performed through a laser, the head unit 230 may selectively adjust a focusing (F) and a defocusing (DF) from the object 400.

When the object 400 is positioned at the focusing F, since the laser output is focused, the metal object 400 may be melted or damaged due to heat. Therefore, in the case of irradiating the laser focusing on the focusing F, there may be a case of irradiating the solder bumps 2 to melt the solder bumps 2.

In addition, when the object 400 is positioned at the defocusing DF, since the output of the laser is dispersed and the laser irradiation area is increased, the object 400 may be positioned at the defocusing DF when heating over a large area. Therefore, when irradiating the laser focusing on the defocusing DF, the temperature difference between the solder bump 2 and the object 400 is minimized to increase the wettability, thereby increasing the bonding area.

Meanwhile, referring to FIG. 5B, the first object 410 and the second objects 420 may be disposed with a predetermined separation distance D on the additionally provided substrate 450 and bonded by solder. Specifically, when the objects 400 (410 and 420) are loaded and transferred on the transfer unit 300, the objects 400 may be disposed spaced apart from each other with a predetermined distance, and disposed on the substrate 450. That is, the substrate 450 and the objects 400 (410 and 420) may be sequentially stacked on the transfer unit 300 upward. Of course, this has been described only for the example of stacking in the vertical direction, and when stacked in the horizontal direction, a member more adjacent from the head unit 230 may be the object 400. In the embodiment of FIG. 5B, the objects 400 (410 and 420) may be spaced apart in the horizontal direction on the substrate, whereas in the embodiment of FIG. 5A, the objects 400 (410 and 420) may be spaced apart in the vertical direction. Therefore, the solder bump 2 is positioned in the spaced space, and in FIG. 5B, the bonding surface 411 may be formed over the first object 410, the second object 420, and the substrate 450.

The bonding surface 411 may be concavely formed on the objects 410 and 420 so that the solder ball S may be discharged and positioned at a predetermined position in the state of the solder bump 2. This may be selectively positioned on one or more members of the first object 410 and the second object 420. In this example, there may be a case where the concavely formed bonding surface 411 may be formed on each of the objects 410 and 420.

The formation of such a bonding surface 411 may lead to the increase in bonding strength by improving the wettability. The improvement in the wettability may be degraded due to the temperature difference between the object 400 and the solder bump 2. Specifically, the temperature of the object 400 is room temperature, and the temperature difference may occur between the high-temperature solder bumps 2 positioned partially melted by the laser. When the wettability on the bonding surface 411 of the first object 410 is reduced due to the temperature difference, the contact area between the solder bump 2 and the object 400 may be reduced.

Accordingly, in order to improve the wettability, the preheating process for reducing the temperature difference may be performed. The preheating process may be performed by changing information such as the height of the head unit 230 or the laser output to form a separation distance between the laser focus and the object by being spaced apart from the laser focus. FIG. 4 is a diagram illustrating the state in which the preheating and heating may be performed through a laser, the head unit 230 may selectively adjust the focusing (F) and the defocusing (DF) from the object 400.

When the object 400 is positioned at the focusing F, since the laser output is focused, the metal object 400 may be melted or damaged due to heat. Therefore, in the case of irradiating the laser focusing on the focusing F, there may be a case of irradiating the solder bumps 2 to melt the solder bumps 2.

In addition, when the object 400 is positioned at the defocusing DF, since the output of the laser is dispersed and the laser irradiation area is increased, the object 400 may be positioned at the defocusing DF when heating over a large area. Therefore, when irradiating the laser focusing on the defocusing DF, the temperature difference between the solder bump 2 and the object 400 is minimized to increase the wettability, thereby increasing the bonding area.

Specifically, referring to the embodiment illustrated in FIG. 5 illustrating the preheating process and the distribution of the solder bumps 2, the objects 400 (410 and 420) positioned at the defocusing DF described above with reference to FIG. 4 may be preheated. The solder bumps 2 may be positioned within the area of the preheated portion. More precisely, the solder bump 2, that is, a periphery of a point to be bonded including the point to be bonded may be a preheating portion (not illustrated). A part of the step or separation distance D between the solder bump 2 and the objects 410 and 420 within the preheated portion may be included, and the solder bump 2 may be introduced into the side of the step or the separation distance D by melting of the solder bumps 2 in the secondary soldering process after the preheating process. As a result of the inflow, the solder may be cured with an inlet part (not illustrated) formed, and the objects 410 and 420 may have an increased bonding surface area to each other by this inlet part, thereby further increasing the bonding force.

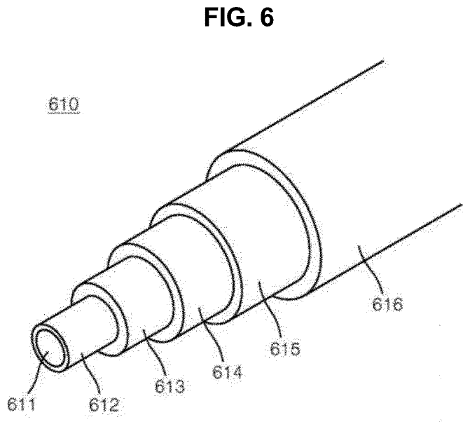

FIG. 6 is a diagram illustrating a configuration of an optical fiber 610 for transmitting a laser according to an embodiment of the present invention.

Referring to FIG. 6, it may be a fiber laser (FL) or a diode laser transmitted through an optical fiber to the head unit 230 of the multi-laser soldering device 100 according to the present invention. The optical fiber 610 may include a core 611 through which the laser beam is transmitted and coatings 612, 613, 614, 615, and 616. Specifically, the core 611 is configured to transmit a laser through total reflection, etc., and the coatings 612, 613, 614, 615, and 616 are configured to protect the core 611 from impact without exposing the core 611 to the outside and one or more of the coatings 612, 613, 614, 615, and 616 may be provided. For example, the plurality of coatings 612, 613, 614, 615, and 616 may include a material such as polyvinyl chloride for shock absorption, aramid yarn for improving durability, polyimide, or silicone.

In addition, the shape of the core 611 positioned in the coatings 612, 613, 614, 615, and 616 may be formed in various ways. The core may have various shapes such as a square, a polygon, a circle, and the like. Depending on the size and shape of the core, the size and quality of the laser may vary.

According to the above-described multi-laser soldering device and soldering method, the device or method according to the embodiment of the present invention may include the following configuration. Meanwhile, the inspection described below may include a first inspection (pre-inspection) and a second inspection (post-inspection) performed by an inspection unit. The first inspection (pre-inspection) may be an inspection that detects a state in which an object is seated, that is, an alignment state including the rotation and disposition state, and a position to be soldered, before the soldering is performed, and the second inspection (post-inspection) may be an inspection that detects one or more types of defects such as open of a solder unit, short, crack and void, excess solder, contamination with a bridge, small solder, cold solder, poor wetting, overheating, corrosion, erosion, misalignment of parts, lifting between parts, and poor solder, after the soldering is performed. As described below, an object that does not satisfy the quality standard as a result of the second inspection may be classified as an object that satisfies the quality standard, and rework (resoldering) may be performed on an object that does not satisfy the quality standard.

First, the laser supplied from the laser supply device may be a laser having a high wavelength of laser absorption according to a solder material. In addition, the laser may also be a solid-state laser such as a fiber laser or a diode laser. The laser beam generated from the laser generator may be transmitted to the laser soldering head through an optical fiber without a separate optical mirror. Accordingly, it may be possible to stably supply a laser and perform the precise manipulation during the soldering by the laser irradiation.

Second, the laser processing device may include a pick and place soldering head including a laser soldering nozzle or a jet soldering head. The laser soldering head may include a laser beam focusing optical head, a solder ball S supply device, and the nozzle. Here, when the laser soldering head means a head unit, it may be configured as a single head as well as a dual head including two heads. In addition, of course, the laser soldering head may be configured as a head body including three or more heads. In this way, when two or more laser soldering heads are included, it is possible to increase the productivity of the device.

Third, the laser soldering device and laser soldering method may include a vision inspection module or a vision inspection step. By including such a vision inspection module or step, it is possible to perform the pre-inspection such as an inspection of a position of a camera module to be soldered, an inspection of an alignment state, an inspection of a position to be soldered, etc, and if necessary, perform the post-inspection such as the inspection of the soldering quality after the soldering. Therefore, 1) by installing a vision inspection module including low and high magnification lenses, or 2) by installing a motorized variable zoom lens (1×˜×18: the highest magnification may be higher depending on the design of the zoom lens), it is possible to perform the automatic inspection from low magnification to high magnification and from a wide area to a narrow area. The pre-inspection and post-inspection may be performed with one vision inspection module, but may be performed with a separate vision inspection module to increase productivity (for example, one for a pre-inspection function and one for a post-inspection function).

When the pre-inspection and the post-inspection are performed with one vision inspection module, an object that has undergone the pre-inspection moves to a position for soldering, soldered, and then returned to a previous position, and thus, undergone the post-inspection. When two vision inspection modules, one for the pre-inspection function and one for the post-inspection function, are provided, an object may be sequentially moved in the order in which the pre-Inspection module, the laser soldering module, and the post-inspection module are positioned, and may be inspected and soldered.

Furthermore, the laser soldering device may further include an infra-red inspection device or a three-dimensional inspection device for controlling parameters by monitoring the soldering quality in real time or for performing the post-inspection such as open of a soldered area, short, crack and void, excess solder, contamination with a bridge, small solder, cold solder, poor wetting, overheating, corrosion, erosion, misalignment of parts, lifting between parts, and poor solder.

Fourth, the laser soldering device may further include a sorting device capable of classifying objects, which are not suitable for the required soldering quality standards after the post-inspection.

Fifth, the laser soldering device may further include a repair device capable of repairing objects, which are not suitable for the required soldering quality standards after the post-inspection. Such a repair device may re-melt a solder unit by re-irradiating a laser to improve solder wettability, or remove pre-soldered solder and perform rework (resoldering). When removing the pre-soldered solder, the pre-soldered solder may be removed automatically by using a mechanical tool such as a pin or automatically removed by re-melted by a laser and suctioned.

Sixth, for the quality control after the soldering, the laser soldering device may further include a cleaning device including a dust collector for removing dust and foreign substances. The layer soldering device may further include, as the cleaning device, at least one of a dry air blowing device, a carbon dioxide (CO₂) snow cleaning device, a laser cleaning device, and an inert gas blowing device.

Seventh, the laser soldering device may further include a pre-soldering unit that performs pre-soldering according to a type of substrate to be soldered. In addition, it is possible to maximize the improvement of soldering quality and productivity by additionally including a laser soldering head.

Further, the multi-laser soldering device according to the present invention may further include a jig. The jig may be a rotating fixture jig that moves in a rotational movement manner. A jig unit (fixture jig channel) including a plurality of jigs employing the rotational movement manner may be provided. For example, jig units (three fixture jig channels) in which three or more jigs moving in the rotational movement manner are coupled to each other may be provided. A plurality of objects to be soldered on may be included or seated in such the jig unit (fixture jig channel). Here, when one or more of soldering and bonding is performed on two or more points of an object, if the soldering or bonding is performed on one of the two points existing on one object, the jig may move so that laser processing may be performed on the other of the two points on the object.

Here, the jig may rotate, move by linear movement, or move by a combination of the rotation and linear movement. When the movement is completed, the soldering or bonding may be performed on the remaining points.

As a specific example, a first head (laser bonding head 1) may perform bonding on a first jig unit (fixture jig channel 1), and a second head (laser bonding head 2) may perform bonding on a third jig unit (fixture jig channel 3). When the heads (laser bonding head 1 and laser bonding head 2) complete the bonding at each position, the first head may perform the bonding on the second jig unit. In addition, when the first jig unit is positioned at an unloading position deviated from the laser irradiation position, the object on which the bonding work is completed may be taken out. A new object may be positioned on the first jig unit from which the object is taken out to wait for bonding work.

When the bonding work is completed on the object positioned in the third jig unit, the object is taken out, and a new object may be positioned on the third jig unit from which the object is taken out to wait for the bonding work.

When the first head completes the bonding work on the object positioned on the second jig unit, the first head may perform the bonding work on the object positioned on the first jig unit. In addition, when the second jig unit is positioned at the unloading position, the object on which the bonding work is completed is taken out, and a new object is positioned on the second jig unit to wait for the bonding work.

When the second head completes the bonding work on the object on the third jig unit, the second head may perform the bonding work on the second jig unit. By repeatedly performing the above bonding work, the laser processing may be performed.

Each object of the jig unit (fixture jig channel) on which the work is completed may perform the bonding quality inspection (post-inspection) with one or two vision inspection module/unit.

Those skilled in the art will appreciate that various modifications and alterations may be made without departing from the spirit or essential feature of the present invention. Therefore, it is to be understood that embodiments described hereinabove are illustrative rather than being restrictive in all aspects. It is to be understood that the scope of the present disclosure will be defined by the claims rather than the description described above and all modifications and alterations derived from the claims and their equivalents fall within the scope of the present disclosure.

1. A laser soldering device applying a multi nozzle, comprising:
a controller;
a transfer unit configured to transfer a plurality of objects;
a solder unit configured to operate under control of the controller to solder the object positioned on the transfer unit, and form a bonding surface by performing the soldering by a laser beam; and
at least one nozzle unit in which a solder ball to which the laser beam is irradiated is accommodated,
wherein the laser beam irradiated from the solder unit is eccentric with respect to a center line of the solder ball and adjusted to be irradiated.

2. The laser soldering device of claim 1, wherein the laser beam irradiated from the solder unit is irradiated while being adjusted within a diameter of the solder ball.

3. The laser soldering device of claim 1, wherein the solder unit includes:
a laser generator configured to generate the laser beam for applying heat to the solder ball;
at least one beam converter configured to adjust an output area or a shape of the laser beam; and
at least one head unit configured to applying the laser beam, which passes through the beam converter and is irradiated to the object, to the solder ball.

4. The laser soldering device of claim 1, wherein the nozzle unit is provided in plurality and is formed to be selectively usable according to a size of the solder ball.

5. The laser soldering device of claim 1, wherein the nozzle unit is provided in plurality, and one end portion of the nozzle unit has a different diameter.

6. The laser soldering device of claim 1, wherein at least one of a dynamic focusing module and a camera module is formed on one side of the solder unit.

7. The laser soldering device of claim 1, wherein the laser beam emitted from the solder unit is a laser beam including a plurality of wavelengths, and each wavelength is transmitted to the object of different types or the same type to perform at least one of soldering, bonding, and welding.

8. The laser soldering device of claim 1, wherein the solder unit further includes an imaging unit configured to process an image of the object through the head unit.

9. The laser soldering device of claim 1, wherein the transmission of the laser is a fiber laser or a diode laser transmitted through an optical fiber to the head unit.

10. The laser soldering device of claim 1, wherein a core of the optical fiber is formed in a circular or polygonal shape.

11. The laser soldering device of claim 1, wherein the object is pre-bonded and transferred by the transfer unit.

12. The laser soldering device of claim 1, wherein the laser beam is irradiated with an output in a flat-top type.

13. The laser soldering device of claim 1, wherein a transfer target of the transfer unit further includes a substrate, and the substrate is arranged so that the object is stacked on the substrate.

14. The laser soldering device of claim 1, wherein one side of the solder unit is provided with a sensor unit measuring a profile of the laser beam.

15. The laser soldering device of claim 1, wherein one side of the solder unit is provided with a sensor unit measuring a position of the laser beam irradiated into a surface of the solder ball or the nozzle.

16. The laser soldering device of claim 1, wherein one side of the solder unit is provided with a sensor unit measuring a size of the laser beam irradiated into a surface of the solder ball or the nozzle.

17. The laser soldering device of claim 1, wherein one side of the solder unit is provided with a sensor unit measuring a melting temperature or a heat distribution of the solder ball.

18. The laser soldering device of claim 1, wherein one side of the solder unit is provided with a sensor unit measuring a temperature or a heat distribution of the object.

19. A laser soldering method, comprising:
a transferring step of disposing an object on a transfer unit;
a monitoring step of recognizing a shape and center of a nozzle unit or a position of a solder ball accommodated in the nozzle unit;
a soldering step of irradiating a laser beam from a laser generator of a solder unit to the solder ball; and
an error range adjustment step of adjusting an irradiation position of the laser beam by checking a displacement of the solder ball according to a change in the position of the solder ball or the nozzle unit.

20. The laser soldering method of claim 19, wherein in the error range adjustment step, the irradiation position of the laser beam is corrected and adjusted to compensate for a displacement separated from a center line of the solder ball or the nozzle unit.
